(19) United States
(12) Patent Application Publication
(10) Pub. No.: US 2006/0019036 A1
(43) Pub. Date: Jan. 26, 2006

(54) Method and apparatus for delivering and applying an electrically conductive paint

(76) Inventors: Frank Herre, Oberriexingen (DE); Rainer Melcher, Obertenfeld (DE); Herbert Martin, Weinstadt (DE); Michael Baumann, Flein (DE); Joachim Hering, Durmentingen (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/512,914

(22) PCT Filed: May 6, 2003
(86) PCT No.: PCT/US03/14470

§ 371 Date: Jul. 11, 2005

(30) Foreign Application Priority Data
May 7, 2002 (US) 60378506
May 27, 2002 (DE) 10223498.1
Aug. 15, 2002 (US) 60403715
Jan. 29, 2003 (US) 60443427

(51) Int. Cl. B05D 1/02; B05B 5/025; H01F 41/00

(52) U.S. Cl. 427/421.1; 427/457; 118/326; 118/50.1; 118/626; 239/3

(57) ABSTRACT

The method of applying an electrically conductive paint of this invention includes delivering paint from a color changer (30) at ground potential, then electrically isolating the color changer (30) from the paint in a delivery line (100), and the delivering the paint through a first delivery line (74) to an electrically charged paint applicator (27). In the disclosed embodiment, paint is delivered from the color changer (30) to a paint cannister (34) having a piston (56) and the piston (56) is then extended to drive paint through the delivery tube (74) to the applicator (27) while the paint cannister (34) is electrically isolated from the color changer (30).

### FIELD OF THE INVENTION

This invention relates to a method and apparatus for delivering and applying an electrically conductive paint by an electrically charged paint applicator which electrically charges the paint at a high voltage received from a color changer at ground potential and which electrically isolates the color changer from the applicator.

### BACKGROUND OF THE INVENTION

The automotive industry, for example, now proposes to replace solvent based paint with water based paint to reduce environmental concerns and pollution abatement apparatus. However, water based paint is highly conductive and in a typical mass production application, the paint is applied with an electrostatic rotary atomizer which electrically charges the paint to improve transfer efficiency. Further, such applications require rapid switching from one color paint to another using a color changer. A color changer is simply a valve system having a number of ports each connected to a source of a different color paint and generally also includes a port connected to a source of solvent, which is typically deionized water for water based paints. The color changer must be at ground potential and the color changer therefore must be electrically isolated from the applicator at high electrical potential.

The prior art has proposed various methods and apparatus for delivering and applying conductive liquid coating materials, such as water based paint, from a source at ground potential, such as a color changer, with an electrically charged paint applicator, such as an electrostatic rotary atomizer, which electrically isolates the source of liquid coating at ground potential from the electrically charged paint applicator, sometimes referred to as a “voltage block.” However, such voltage block devices are often complex, expensive, subject to failure and limited in application. The prior art has also proposed electrically isolating a predetermined quantity or volume of electrically conductive paint between a front and rear pig in the delivery line between the color changer and the applicator which are moved through the delivery line by pneumatic pressure. This method is also, however, limited in application and requires a delivery line of sufficient length such that the delivery line is longer than the distance between the front and rear pigs. There is therefore a need for a simple, reliable method and apparatus for conveying and applying a conductive paint from a color changer at ground potential to an electrically charged paint applicator, such as an electrostatic rotary atomizer, which avoids the problems associated with the prior art as set forth hereinbelow.

### SUMMARY OF THE INVENTION

As set forth above, the method and apparatus of this invention is adapted to apply an electrically conductive paint, such as a water based paint, to a substrate with an electrically charged paint applicator, such as an electrostatic rotary atomizer, from a source of paint at ground potential, particularly, but not exclusively a color changer. As used herein, the term “paint” includes water based paints and generally any liquid coating, particularly including coatings for protective or decorative purposes. The method and apparatus of this invention is, however, particularly directed to the application of an electrically conductive paint which is applied to a substrate with an electrically charged paint applicator, such as an electrostatic rotary atomizer, and wherein the source of the electrically conductive paint is at ground potential. As used herein, the term “color changer,” includes any valving system adapted to deliver different paints, as this term is defined above.

The method of applying an electrically conductive paint to a substrate of this invention is particularly adapted for mass production applications, wherein the substrate is located in a confined paint spray booth and the electrically charged paint applicator is located in the paint spray booth. In a typical application, the paint applicator may be a robotic paint applicator typically mounted on rails which move with the substrate, such as an automotive body. However, the paint applicator may be an electrically charged paint spray gun or overhead or side mounted electrostatic rotary atomizers of the type presently used in mass production applications including, but not limited to the automotive industry. As set forth above, the apparatus further includes a color changer, as defined above, at ground potential and the electrically conductive paint is delivered through a delivery line, such as a plastic tube, preferably having a friction resistant inner layer and an intermediate dielectric layer, such as polyethylene, to prevent arcing.

The method of this invention then includes delivering the electrically conductive paint from the color changer at ground potential, then electrically isolating the color changer from both the delivery line and the electrically conductive paint. Finally, the method of this invention includes delivering the electrically conductive paint through the delivery line to the electrically charged paint applicator, thereby charging the conductive paint and applying the paint to a substrate while the color changer is electrically isolated from the paint in the delivery line. In a preferred embodiment, the conductive paint in the delivery line is a continuous stream which is electrically charged by the paint applicator.

One preferred embodiment of the method of this invention includes delivering the electrically conductive paint from the color changer to a paint cannister through a second delivery line between the color changer and the paint cannister, then electrically isolating the color changer from the paint cannister and finally delivering the electrically conductive paint from the paint cannister to the electrically charged paint applicator through the first delivery line described above. In one preferred embodiment, the second delivery line between the color changer and the paint cannister includes a pig or pigging element driving paint in the second delivery line from the color changer to the paint cannister, wherein the pigging element is driven by a nonconductive fluid, such as air, thereby electrically isolating the color changer from the paint cannister. In a preferred embodiment of the method of this invention, the paint cannister further includes a piston, wherein the method of this invention includes retracting the piston in the paint cannister to receive the conductive paint from the color changer, then extending the piston to drive the conductive paint through the first delivery line to the electrically charged paint applicator while the paint cannister is electrically isolated from the color changer.

In a preferred embodiment of the apparatus of this invention, the piston of the paint cannister is driven by a servomotor providing very accurate dosing of paint. The first delivery -line between the paint cannister and the applicator may also include a pigging element which is driven by the conductive paint from the paint cannister to a pig station adjacent the applicator. The pigging element is then driven by pneumatic pressure from the applicator to adjacent the paint cannister, thereby returning paint in the first delivery line to the paint cannister and electrically isolating the applicator from the paint cannister. The paint returned to the paint cannister can then be returned to the color changer by again extending the piston of the paint cannister.

A preferred embodiment of the apparatus for delivering and applying an electrically conductive paint of this invention thus includes a paint spray booth, an electrically charged paint applicator located within the paint spray booth and a color changer at ground potential preferably located outside the paint spray booth, which may be conventional as known by those skilled in this art. The apparatus of this invention further includes at least one paint cannister connected to the color changer by the second delivery line described above having a pig or pigging element movable between the color changer and the paint cannister to deliver paint in the second delivery line to the paint cannister and electrically isolate the color changer from the paint cannister following delivery of paint to the paint cannister as described above. The apparatus of this invention also includes a first delivery line from the paint cannister to the electrically charged paint applicator. In a preferred embodiment, the apparatus further includes a pig or pigging element in the first delivery line which is pushed by the conductive paint from the paint cannister to the paint applicator. Paint remaining in the first delivery line may then be driven to the paint cannister by the pigging element in the first delivery line by a nonconductive fluid, such as pressurized air or pneumatic pressure, wherein the piston in the paint cannister is retracted to receive the paint and the piston in then extended to return the paint to the color changer. As set forth above, the piston of the paint cannister is preferably driven by a servomotor or the like providing a very accurate metered volume or dose of paint to the paint applicator, which can be varied for each application of paint depending upon the application. In one preferred embodiment of the apparatus of this invention, the color changer and at least one paint cannister are located outside the paint booth in an isolation cabinet preferably formed of an electrically insulated or dielectric material.

Other advantages and meritorious features of the method and apparatus for delivering and applying an electrically conductive paint of this invention will be more fully understood from the following description of the preferred embodiments, the appended claims and the drawings, a brief description of which follows.

### BRIEF DESCRIPTION OF THE DRAWINGS

FIG. 1 is a side elevation of a paint spray booth illustrating one embodiment of an exterior isolation cabinet;

FIG. 2 is an enlarged view of the isolation cabinet shown in FIG. 1;

FIG. 3 is a side partially cross-sectioned view of one embodiment of a paint dosing cylinder or cannister illustrated in FIGS. 1 and 2; and

FIGS. 4A to 4H are schematic illustrations of the method of delivering and applying an electrically conductive paint of this invention.

### DESCRIPTION OF THE PREFERRED EMBODIMENTS

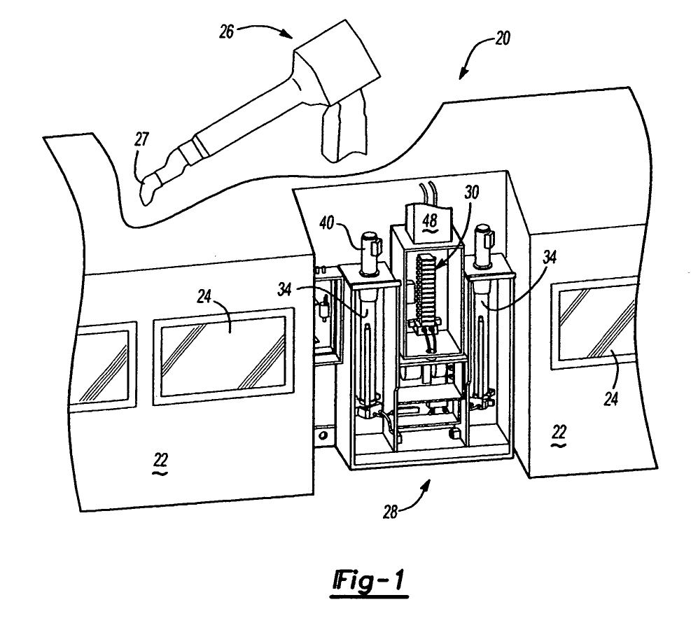

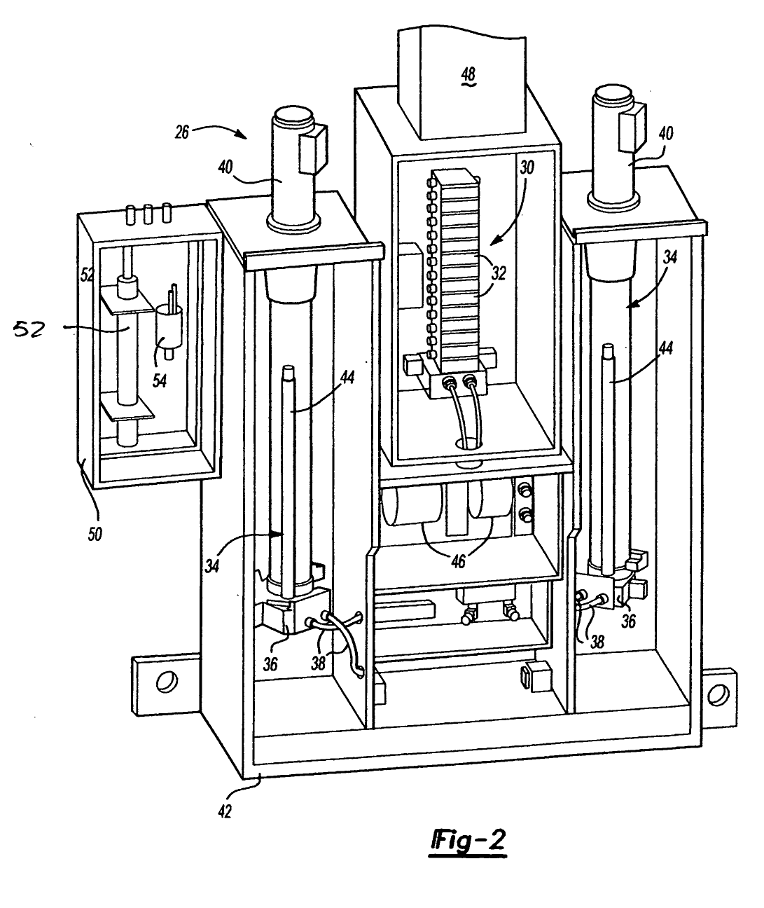

As set forth above, the method and apparatus for delivering and applying an electrically conductive paint (as defined above) of this invention may be utilized in mass production applications, such as illustrated in FIG. 1, wherein electrically conductive paint is applied to a substrate in an enclosed clean environment which includes one or several paint applicators as described below. The paint spray booth 20 is defined by an enclosure wall 22, which may include windows 24 for viewing the paint spray booth and at least one paint applicator, such as the robot paint applicator 26 illustrated. As will be understood, a conventional paint applicator is generally mounted on a rail (not shown) which moves with the substrate, such as an automotive body, to apply electrically conductive paint through an applicator at high voltage, such as the electrostatic rotary atomizer 27 illustrated in FIG. 1. In a preferred embodiment of the method and apparatus of this invention, the electrically conductive paint is electrostatically charged to a high voltage as it is received through the paint applicator 27 as described further hereinbelow. In one preferred embodiment of the apparatus of this invention, the paint cannisters 34 and color changer 30 are located outside the paint spray booth 20 in an electrically insulated isolation cabinet or voltage block module 28 as shown in FIG. 1 and FIG. 2 is an enlarged view of the voltage block module 28 as now described.

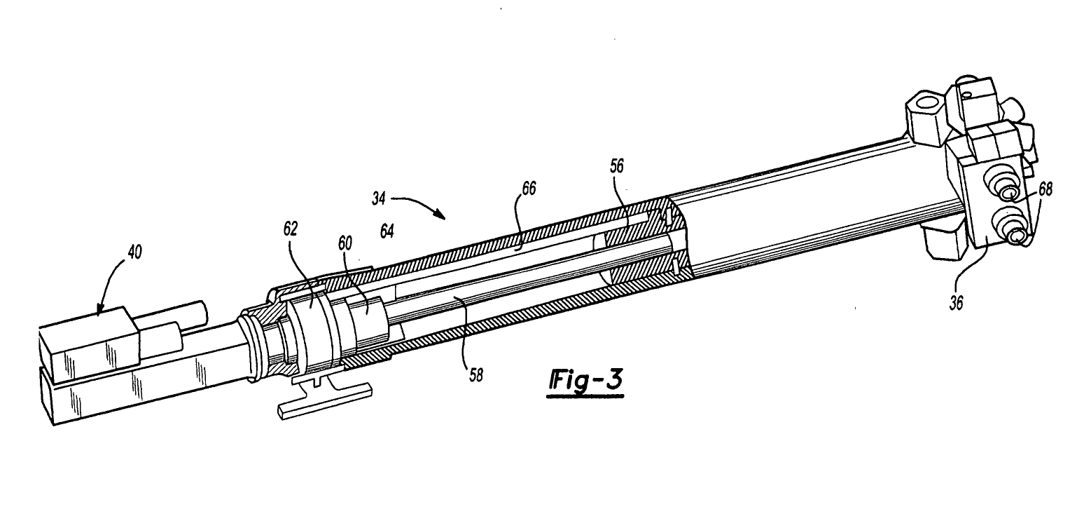

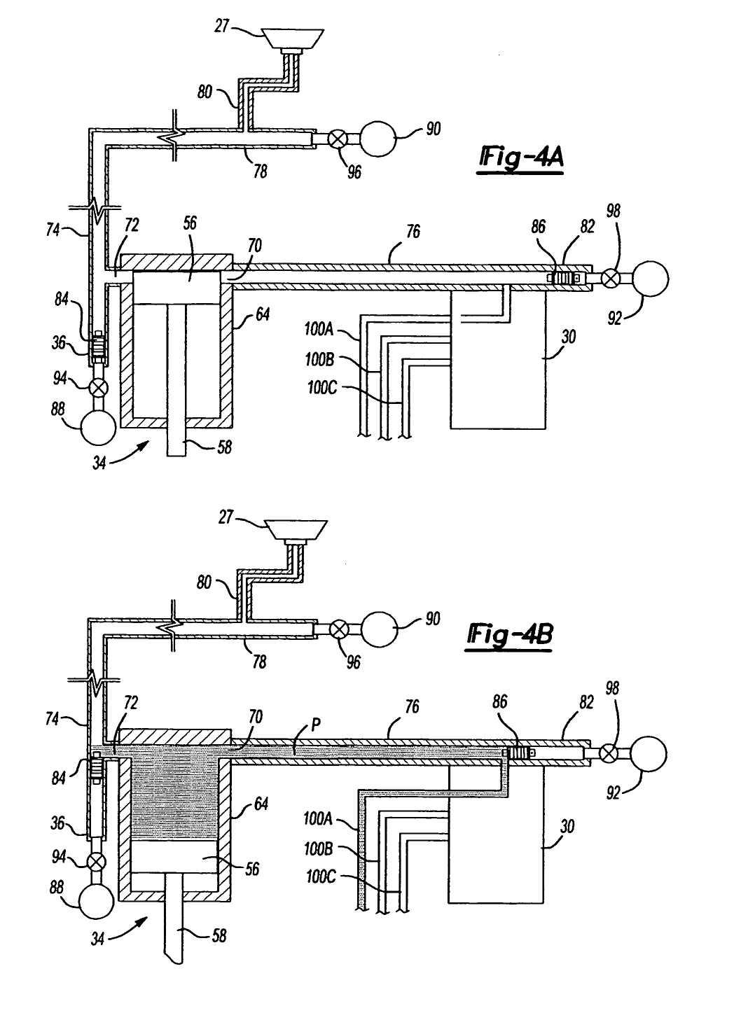

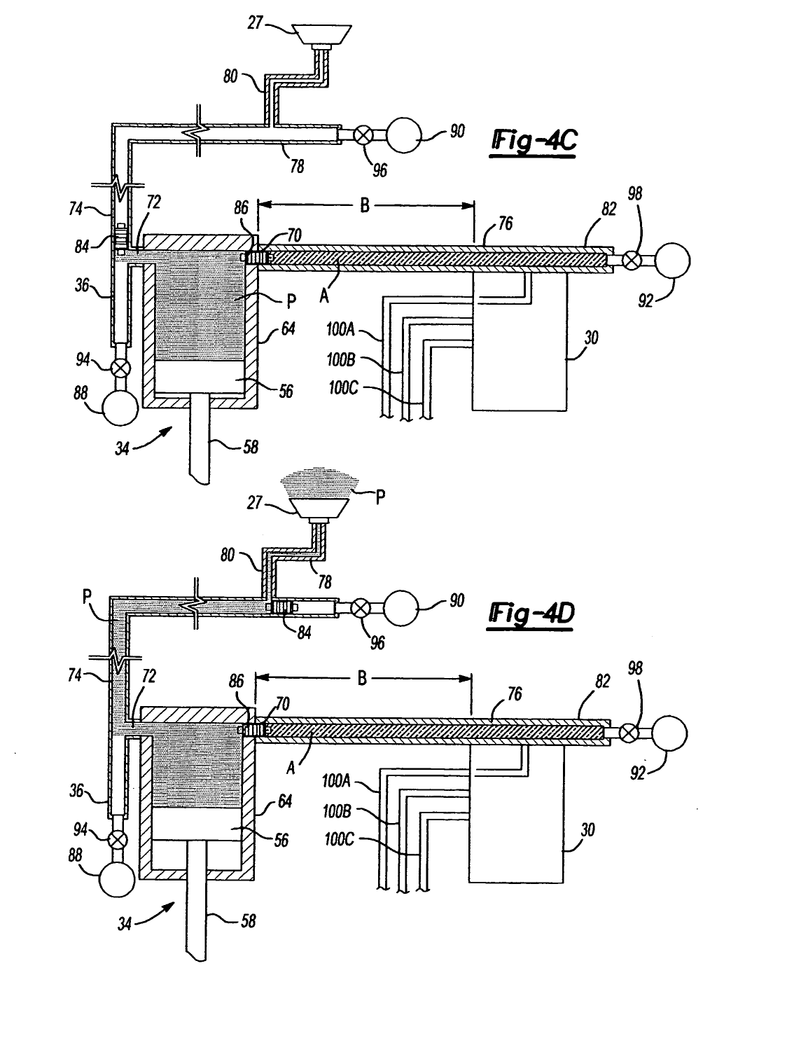

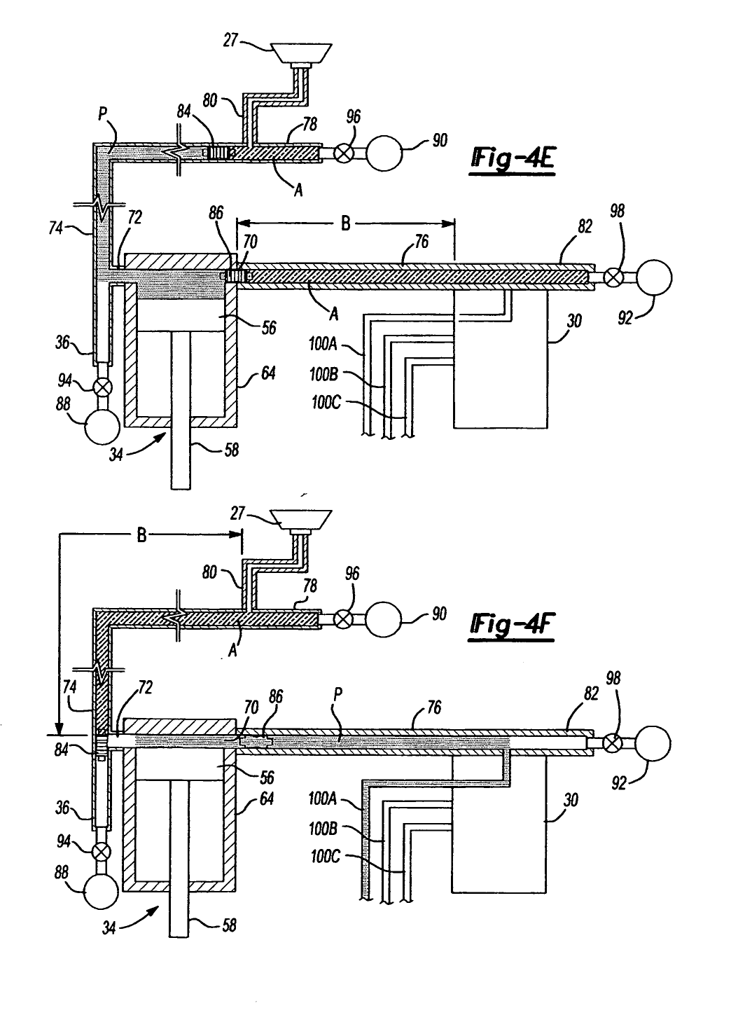

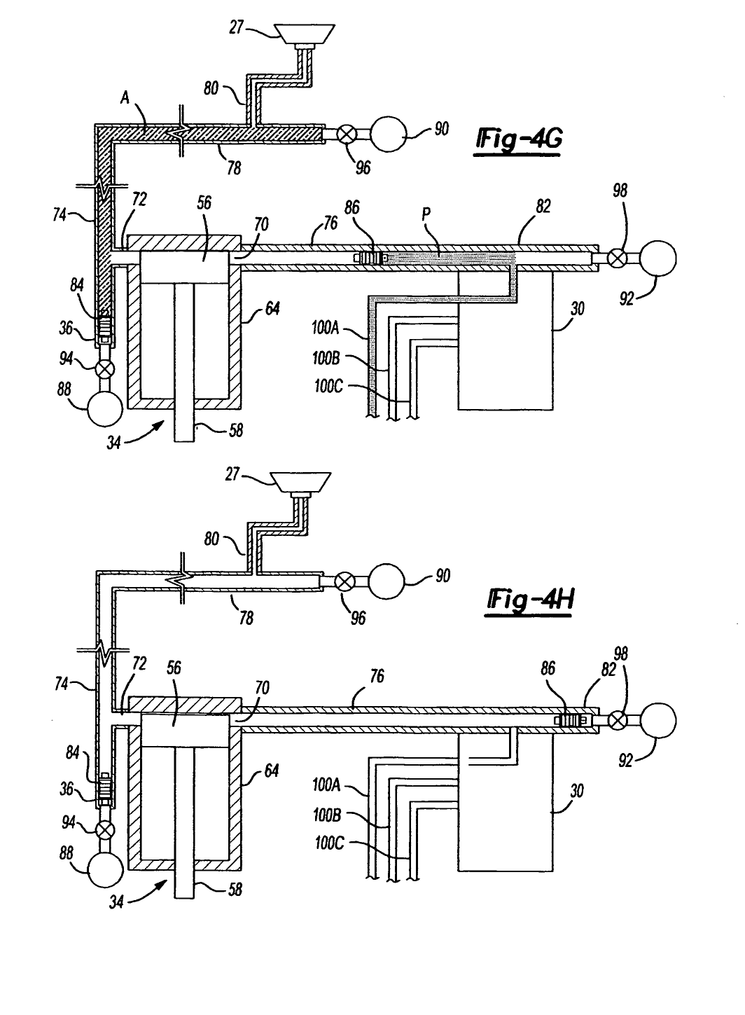

The voltage block module or electrical insulation cabinet 28 shown in FIG. 2 includes a color changer 30 which, as described above, includes a plurality of valve modules 32 each connected to a source of different colored electrically conductive paint (not shown). This embodiment of the voltage block module 28 further includes two paint dosing devices or paint cannisters 34 each including a pig station 36 connected by supply or delivery lines 38 to color changer 30 and the applicator 26 shown in FIG. 1 and described further below in regard to FIGS. 4A to 4H. In one preferred embodiment, the paint cannisters 34 each include a piston 56 as described below with respect to FIG. 3 having a servomotor drive 40, such that the cannisters 34 each provide an accurate volume or “dose” of paint to the applicator 27 shown in FIG. 1. In a preferred embodiment, the voltage block module is defined by an electrically insulated cabinet frame 42, preferably formed of a nonconductive or electrically insulating polymer, such as Delrin®, an acetal polymer available from DuPont, or other suitable nonconductive polymers. As described further in a co-pending application assigned to the assignee of this application, the voltage block module 28 includes resistors 44, such as 9 G ohm resistors, solvent cannisters 46 and a hood or enclosure 48 which receives the lines from the paint cannisters 34 to the applicator (not shown). The disclosed embodiment of the electrical isolation cabinet or voltage block module 28 further includes a grounding switch cabinet 50 which includes various electrical components, including a high voltage cascade or voltage generator 52 and a grounding switch 54. However, in view of the fact that the specific components of the electrical isolation cabinet or voltage block module 28 does not form a part of this invention, except for the color changer and paint dosing cylinders 34, no further explanation is necessary for complete understanding of the invention as claimed.

FIG. 3 illustrates one preferred embodiment of the paint cannister or paint dosing cylinder 34 shown in FIG. 2. The disclosed embodiment of the paint dosing cylinder 34 may correspond to the device disclosed in German Patent Application No. DE 10233633 and includes a piston 56 connected to a piston guide rod 58, which is connected to a bearing 60 and a gear drive 62 connected to a servomotor drive 40. The piston 56 reciprocates in a piston cylinder or housing 64 which is preferably formed of a ceramic material providing electrical isolation for receipt of charged conductive paint as described below. The piston 56 may further include a guide rod 66 as shown. As described above, a preferred embodiment of the paint piston dosing device 34 includes a pig station 36 having ports 68 for receipt of the delivery lines 38 shown in FIG. 2. The components of the apparatus illustrated in FIGS. 1 to 3 will be more fully understood from the following description of the method of delivering and applying an electrically conductive paint shown in FIGS. 4A to 4H described below.

FIGS. 4A to 4H illustrate schematically the apparatus described above, including the paint applicator 27 at high voltage, a color changer 30 at ground potential, at least one paint canister or paint dosing cylinder 34 including a piston 56, reciprocable in a piston cylinder or housing 64 having a piston rod 58 preferably connected to a servomotor drive 40 shown in FIG. 3 and a pig station 36 at one end of the piston dosing device 34. The housing 64 of the piston dosing device 34 includes an inlet 70 and an outlet 72 in fluid communication with the first delivery line 74 between the piston dosing device 34 and the applicator 27 and the inlet 70 is connected by a second delivery line 76 to the color changer 30. The disclosed apparatus further includes a second pig station 78 adjacent the applicator 27 which is connected to the first delivery line 74 by a line 80. The color changer also includes a third pig station 82 adjacent or located within the color changer 30. As shown in FIG. 4A, the first and second pig stations 36 and 78, respectively, are preferably in the form of trunk lines of the first delivery line 74, such that paint or other fluid can flow from the outlet 72 of the paint cannister or piston dosing device 34 to the applicator 27 through line 80 without flowing around the pig or pigging element 84. Similarly, the third pig station 86 is preferably a trunk line of the second delivery line 76, such that paint or other fluid can flow from the color changer 30 through the second delivery line 76 without flowing past the pig or pigging element 86 in the third pig station 82. However, as described further below, the inlet 70 of the paint cannister or piston dosing device 34 may be configured to receive paint around the second pigging element 86. Further, each of the pig stations 36, 78 and 82 include a source of nonconductive fluid under pressure 88, 90 and 92, respectively, which are controlled by valves 94, 96 and 98, respectively. Having described one preferred embodiment of the apparatus of this invention, the method of delivering and applying an electrically conductive paint of this invention may now be described with reference to FIGS. 4A to 4G as described below.

As set forth above, the color changer 30 comprises a series of valves each having a port connected to a separate source of liquid paint under pressure (not shown) by lines 100A, 100B and 100C. In a typical application, the lines 100A, 100B and 100C are connected to separate sources of liquid paint having different colors for application to a substrate by applicator 27, such as automotive bodies received through the paint spray booth 20 illustrated in FIG. 1. As set forth above, the color changer 30 must be at ground potential because the color changer is connected by lines 100A, 100B and 100C to sources of liquid paint. Further, the applicator 27 is at a high voltage or high electrical potential and applies a high electrical charge to the paint as it is received through the applicator 27 and the substrate (not shown) is generally at ground potential to improve transfer efficiency. Thus, paint is received through one of the lines 100A, 100B or 100C.

In FIG. 4B, paint “P” is received through line 100A to the color changer 30 and the paint is then delivered under pressure through the second delivery line 76 to the paint cannister 34. As set forth above, the piston guide rod 58 may be connected to a servomotor drive 40 illustrated in FIGS. 2 and 3, which withdraws the piston 56 to receive a predetermined volume or “dose” of paint in cylinder 64 of the paint piston dosing device 34 as shown in FIG. 4B. As shown, the first pigging element 84 is then located in the first pig station 36 and the second pig or pigging element 86 is then located in the third pig station 82 and the pigging elements do not block the flow of paint. The valve 98 in the third pig station 82 is then opened, driving nonconductive fluid, such as air “A,” from the source 92 against the second pigging element 86, which drives the second pigging element through the second delivery line 76 to the paint dosing device 34, driving conductive paint P-remaining in the second delivery line 76 to the paint cannister or paint dosing device 34 as shown in FIG. 4C, thereby electrically isolating or creating a voltage block “B” between the color changer 30 and the paint cannister 34 as illustrated by the arrows in FIGS. 4C to 4E. As the second pigging element 86 is moved to the paint cannister 34, the piston 56 is simultaneously withdrawn to fully charge the paint cannister or dosing device 34 as shown in FIG. 4C. As will be understood, however, the piston 56 may be controlled to deliver any predetermined volume or dose of paint for delivery to the applicator 27, as now described.

While the paint cannister or dosing device 34 is electrically isolated from the color changer 30, as shown by “B”, the piston 56 is then reversed, driving paint P through the first delivery line 74 and line 80 to the applicator 27, thereby electrically charging the paint and applying the paint through the applicator 27 to a substrate (not shown) in the paint spray booth 20 shown in FIG. 1. In this embodiment, the valve 94 to the source of nonconductive fluid 88 is opened to drive the first pigging element 84 ahead of the paint P as the paint is driven from the paint cannister 34 to the applicator 27, thus receiving the first pigging element 84 in the second pig station 78 as shown in FIG. 4D. Alternatively, the pigging element 84 may remain in the first pig station 36 and pneumatic pressure may then be utilized from source 88 to drive paint remaining in the first delivery line 74 to the paint applicator 27. In the embodiment disclosed, upon completion of the first paint cycle, the valve 96 is open to the source of nonconductive fluid 90, driving the first pigging element 84 from the second pig station 78 adjacent the applicator 27 to the first pig station 36 adjacent the paint dosing device 34, thereby returning paint P remaining in the first delivery line 74 to the paint dosing device 34 as shown in FIG. 4E. The paint applicator 27 is thus electrically isolated from the paint cannister forming a voltage block “B” as shown in FIG. 4F. The piston 56 in the paint dosing device 34 is simultaneously retracted to receive the paint P delivered from the first delivery line 74 by the first pigging element 84. The piston 56 of the paint dosing device 34 is then extended again, driving paint from the paint cannister or piston dosing device 34 to the color changer 30 and through line 100A to the original source of conductive paint as shown in FIG. 4F. Finally, the second pigging element 86 is driven through the second delivery line 76 from adjacent the paint cannister or piston dosing device 34 to the color changer, returning the paint in the second delivery line 76 to the color changer 30 and from the color changer to the source of liquid paint through line 100A by driving the second pigging element 86 through the second delivery line 76 as shown in FIGS. 4G and 4H.

As will be understood from the above description, the method of this invention includes delivering electrically conductive paint P from the color changer 30 and then electrically isolating the color changer 30 from the electrically conductive paint P, then delivering the electrically conductive paint through the first delivery line 74 to the electrically charged paint applicator 27, thereby electrically charging the electrically conductive paint. In one preferred embodiment, the conductive paint is a continuous stream to the applicator 27 in the delivery line 74 as shown, for example, in FIGS. 4D and 4E. In a preferred embodiment of the method of this invention, the electrically conductive paint is first delivered to a paint cannister, such as the piston dosing device 34 as shown in FIG. 4C and the color changer 30 is then electrically isolated from the piston dosing device 34 as shown in FIG. 4C. In the disclosed embodiment, the color changer 30 is electrically isolated from the piston dosing device 34 by driving the second pigging element 86 through the second delivery line 76, forming a voltage block B as shown in FIG. 4C. As will be understood by those skilled in this art, however, the color changer 30 may be electrically isolated from the piston dosing device 34 by pneumatic pressure, although a pigging element 86 is shown is preferred. The paint P is then driven by the piston 56 to the electrically charged applicator 27 through line 74 as shown in FIG. 4D while the color changer 30 is electrically isolated from the electrically conductive paint and the piston dosing device 34.

As will be understood by those skilled in this art, various modifications may be made to the method and apparatus for delivering and applying an electrically conductive paint of this invention within the purview of the appended claims. For example, the piston dosing device or paint cannister 34 may be eliminated, provided the color changer is electrically isolated from the first delivery line 74 and the paint P contained therein prior to delivery paint to the electrically charged applicator 27. Although a piston dosing device of the general type is preferred, the first delivery line 74 may be of any length, including a coil, providing sufficient length to provide a voltage block as by utilizing a second pigging element 86 as described above. Further, the first pigging element 84 may be utilized to deliver paint remaining in the first delivery line 74 to the paint applicator 27, rather than returning the paint to the color changer 30 as described above. Having described preferred embodiments of the method and apparatus for delivering and applying electrically conductive paint of this invention, the invention is now claimed as follows.

1. A method of applying an electrically conductive paint to a substrate located in a paint spray booth with an electrically charged paint applicator located within said paint spray booth from a color changer at ground potential, said method comprising the following steps:
delivering electrically conductive paint through a first delivery line from said color changer at ground potential to a paint cannister located outside said paint spray booth having a reciprocable piston and retracting said piston to receive a predetermined volume of electrically conductive paint in said paint cannister;
then electrically isolating said color changer from said paint cannister and said electrically conductive paint in said paint cannister; and
then delivering said electrically conductive paint through a second delivery line from said paint cannister located outside said paint spray booth to said electrically charged paint applicator located within said paint spray booth by extending said piston to drive a predetermined volume of electrically conductive paint from said paint cannister to said electrically charged paint applicator, thereby electrically charging said electrically conductive paint and applying said electrically conductive paint to said substrate with said color changer electrically isolated from said paint cannister and said electrically conductive paint.

2. The method of applying an electrically conductive paint to a substrate as defined in claim 1, wherein said color changer is connected to said paint cannister by said first delivery line having a pig movable in said first delivery line, said method including moving said pig from adjacent said color changer to adjacent said paint cannister, thereby delivering said electrically conductive paint to said paint cannister and electrically isolating said color changer from said paint cannister.

3. The method of applying an electrically conductive paint to a substrate as defined in claim 2, wherein said method includes driving said pig from adjacent said color changer to adjacent said paint cannister with a non-conductive fluid.

4. The method of applying an electrically conductive paint to a substrate as defined in claim 2, wherein said method includes delivering a predetermined volume of said electrically conductive paint from said color changer to said paint cannister through said first delivery line, then driving said pig through said first delivery line with a nonconductive fluid from adjacent said color changer to adjacent said paint cannister to deliver said electrically conductive paint in said first delivery line to said paint cannister and electrically isolate said color changer from said paint cannister.

5. The method of applying an electrically conductive paint to a substrate as defined in claim 1, wherein said method includes delivering said electrically conductive paint under pressure from said paint cannister to said electrically charged paint applicator within said paint booth through said delivery line in a continuous stream, electrically charging said electrically conductive paint in said delivery line only when said color changer is electrically isolated from said delivery line and said electrically charged paint.

6. A method of applying an electrically conductive paint to a substrate located in a paint spray booth with an electrically charged applicator located within said paint spray booth from a color changer at ground potential through a delivery line, said method comprising the following steps:
delivering said electrically conductive paint under pressure through a first line from said color changer at ground potential to a paint cannister;
then electrically isolating said color changer from said paint cannister and said electrically conductive paint in said paint cannister by driving a pig with nonconductive fluid pressure through said first line from said color changer to said paint cannister;
then delivering said electrically conductive paint through a second delivery line from said paint cannister to said electrically charged paint applicator, electrically charging said electrically conductive paint and applying said charged electrically conductive paint to said substrate.

7. The method of applying an electrically conductive paint to a substrate as defined in claim 6, wherein said method includes driving a second pig from said electrically conductive paint applicator to said paint cannister following applying paint to said substrate with a nonconductive fluid to electrically isolate said electrically charged paint applicator from said paint cannister prior to delivering a second paint from said color changer to said paint cannister.

8. An apparatus for applying an electrically conductive paint to a substrate, comprising:
a paint spray booth;
an electrically charged paint applicator within said paint spray booth;
a color changer located outside said paint spray booth at ground potential;
at least one paint cannister having a reciprocable piston;
a first delivery line from said paint cannister to said electrically charged paint applicator adapted to deliver electrically conductive paint to said electrically charged paint applicator; and
a second delivery line between said paint cannister and said color changer having a pig movable therein between said color changer and said paint cannister to deliver paint in said second delivery line to said paint cannister and electrically isolate said color changer from said paint cannister and said electrically conductive paint when paint is delivered from said paint cannister to said electrically charged paint applicator, charging said electrically conductive paint.

9. The apparatus for applying an electrically conductive paint as defined in claim 8, wherein said paint cannister is located outside said paint spray booth in an electrically insulated cabinet.

10. The apparatus for applying an electrically conductive paint as defined in claim 8, wherein said paint cannister includes an inlet communicating with said second delivery line, an outlet communicating with said first delivery line, and said piston movable within said paint cannister adapted to move away from said inlet upon receipt of said electrically conductive paint from said color changer and move toward said outlet to drive electrically conductive paint under pressure through said first delivery line to said electrically charged paint applicator.

11. The apparatus for applying an electrically conductive paint as defined in claim 10, wherein said piston is driven by a servomotor.

12. The apparatus for applying an electrically conductive paint as defined in claim 8, wherein said apparatus includes a second paint cannister having a reciprocable piston connected to said color changer by a third delivery line having a pig movable between said color changer and said second paint cannister to deliver electrically conductive paint from said color changer to said second paint cannister and electrically isolate said color changer from said second paint cannister following delivery of electrically conductive paint to said
